(19) United States
(12) Patent Application Publication
(10) Pub. No.: US 2008/0272108 A1
(43) Pub. Date: Nov. 6, 2008

(54) Bistro Table Heater Combination with 360 Degree Heat Source

(75) Inventors: Ken Maitland, Bowling Green, KY (US); Jerry McColgin, Westfield, IN (US); Maureen Carroll, Atlanta, GA (US); Michael E. Docherty, Boca Raton, FL (US); Pete Moyer, Bowling Green, KY (US); Chungkin Yee, Bowling Green, KY (US); Griffin Bland, Bowling Green, KY (US); Jeff Clack, Bowling Green, KY (US)

Correspondence Address: MIDDLETON & REUTLINGER, 2500 BROWN & WILLIAMSON TOWER, LOUISVILLE, KY, 40202, US

(73) Assignee: Desa IP, LLC, Miami, FL (US)

(21) Appl. No.: 11/684,955

(22) Filed: Mar. 12, 2007

(51) Int. Cl. H05B 1/00

(52) U.S. Cl. 219/218

(57) ABSTRACT

In one embodiment the instant invention combines a table and a heater in one device. The heater allows heat to escape laterally beneath the table to warm the lower extremities of a user. The heater may use propane as a fuel source, and the fuel source may be self-contained and mountable adjacent to the heater. The device may be mounted on wheels so as to be portable. The table may have several deflectors below it and above the heater so that the table does not get hot.

### STATEMENT REGARDING FEDERALLY SPONSORED RESEARCH OR DEVELOPMENT

Not applicable.

### BACKGROUND OF THE INVENTION

### Field of the Invention

The present invention relates to a combination table and heater. More particularly, the invention relates to a pillar heater having a table top that can be used for outdoor dining and recreation.

### BRIEF DESCRIPTION OF THE DRAWINGS

The aspects and advantages of the present invention will be better understood when the detailed description of the preferred embodiment is taken in conjunction with the accompanying drawings, in which:

FIG. 1 is a plan view of one embodiment of the invention;

FIG. 2 is an exploded view of an embodiment of the invention;

FIG. 3 is an exploded view of the base and support pillars of the invention;

FIG. 4 is a perspective view of a cabinet assembly of the invention;

FIG. 5 is an exploded view of an embodiment of the heating area or combustion chamber of the invention;

FIG. 6 is an exploded view of a grate and emitter assembly of the invention;

FIG. 7 is an exploded view of the emitter assembly of the invention;

FIG. 8 is a perspective view of an embodiment of the grate of the invention;

FIG. 9 is an exploded view of the deflector pans of one embodiment of the invention;

FIG. 10 is an exploded view of the table top of an embodiment of the invention; and

FIG. 11 is a perspective view of one embodiment of the invention.

### DETAILED DESCRIPTION OF THE DRAWINGS

While this invention is capable of embodiments in many different forms, multiple embodiments are shown in the figures and will be herein described in detail. The present disclosure is to be considered an exemplification of the principles of the invention and is not intended to limit the broad aspects of the invention to the embodiments illustrated.

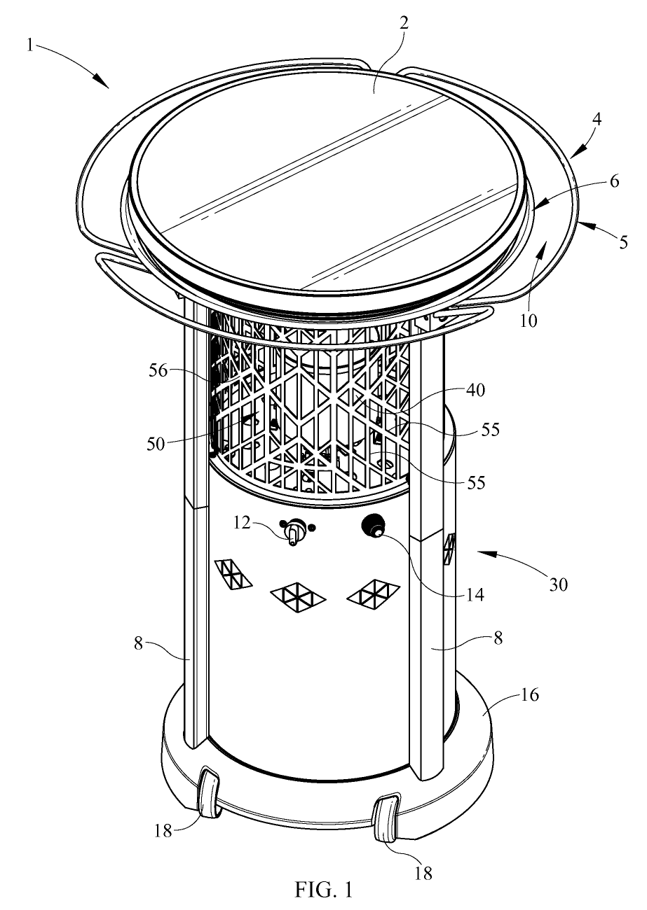

Referring now to FIG. 1, in one embodiment the bistro table heater 1 of the invention comprises a table top 2 having a heating area or combustion chamber 50 below it. The heating area or combustion chamber 50 comprises a heat source, which in FIG. 1 is a radiant emitter assembly 40 positioned below the table top 2. Heat emanates from the heating area or combustion chamber 50 in a 360 degree pattern around the bistro table heater 1 due to the burner 60 and the grate 56 of the heating area or combustion chamber 50. The heating area or combustion chamber 50 is covered by a grate 56 having a plurality of apertures 55. The apertures 55 of the grate 56 allow heat out of the heating area or combustion chamber, but the grate 56 partially shields the burner 60 of the heating area or combustion chamber 50 from weather or other physical interference. While apertures 55 are shown in one embodiment, the wall of the heating area or combustion chamber 50 may also be constructed with slots, openings or simple continuous heat radiating surfaces, all designed to allow heat to radiate outward from the chamber 50.

In the embodiment shown in FIG. 1, the table 2 is surrounded by a heat guard rail 4 attached to the support pillar 8. The heat guard rail 4 allows people sitting or standing near the table heater 1 to lean against the rail 4 for support. The heat guard rail 4 has an outside edge 5 that defines an extended area 10 between the heat guard rail 4 and the table 2. In the embodiment shown in FIG. 1, the extended area 10 is an empty space, although it may comprise other configurations and connections to the heater 1. The heat guard rail 4 causes people to maintain a distance at least the width of the extended area 10 from the heating area 50. Given its relatively close proximity to the heating area 50, the table 2 may become somewhat warm after extended use, but due to the design of the table heater 1, the temperature of the table 2 should not become elevated enough to cause pain or discomfort to anyone who leans against it, even if they do so for an extended period of time.

Below heating area or combustion chamber 50 is cabinet assembly 30. Generally, cabinet assembly 30 has enough space to store the energy source for the heat source so that the table heater 1 functions as a self-contained unit, and can be easily moved as desired. The energy source, a propane tank in one embodiment, should fit within the cabinet assembly 30 and rest on base 16. In the embodiment shown in FIG. 1, base 16 has wheels 18 that ensure the mobility of table heater 1.

The embodiment shown in FIG. 1 further comprises a control knob 12 and ignitor 14 located on the outside of the cabinet assembly 30. Several support pillars 8 vertically extend along the length of the table heater 1 at several places on the heater. The support pillars 8 connect to other parts of the table heater 1 in order to maintain the physical integrity of the entire structure.

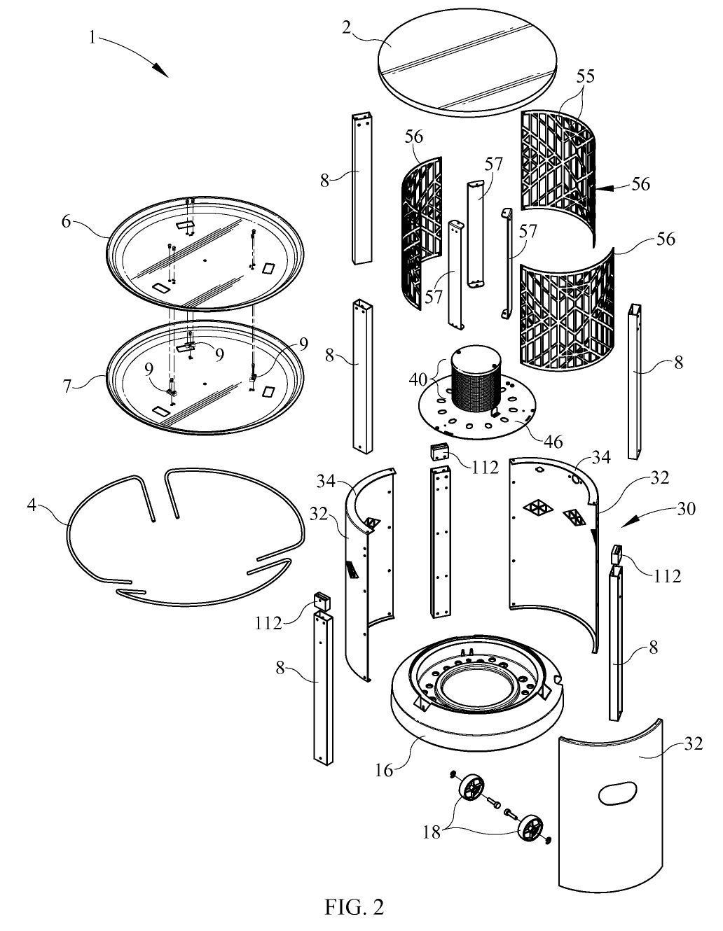

In one embodiment, the bistro table heater 1 comprises one or more support pillars 8 that add stability and rigidity to the design of the table. In the embodiment shown in FIG. 2, the support pillars 8 can vertically traverse the length of the table heater 1 up to the deflectors 6, 7 at different points on each perimeter. The support pillars 8 are spaced at intervals around the heater 1 to ensure that the whole of the heating area or combustion chamber 50 and the cabinet assembly 30 are adequately supported. A base 16 sits at the bottom of the table heater 1.

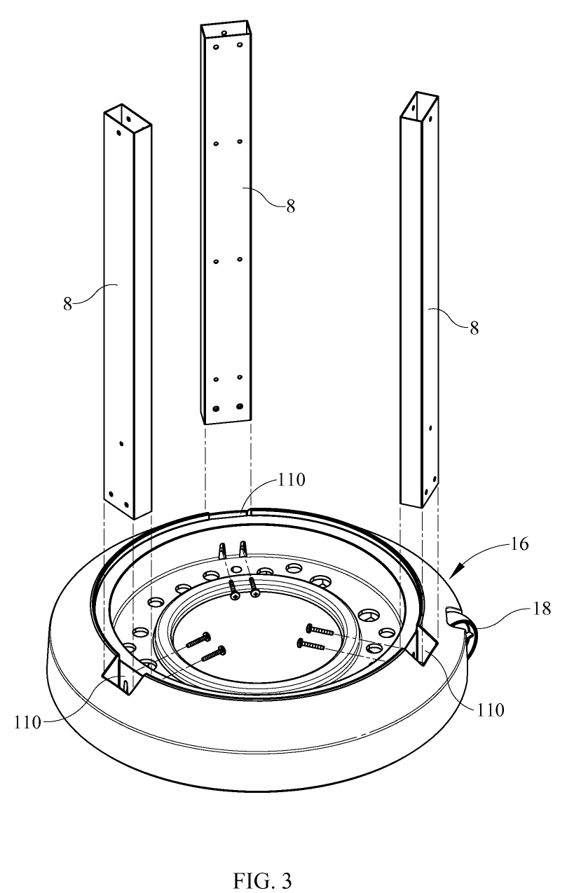

FIG. 3 shows how the support pillars 8 attach to the base 16, and wheels 18 are also visible. In the embodiment shown in FIG. 2, the pillars 8 are hollow and are made of a strong metal material. The bottom of the individual pillars 8 insert into notches 110 in base 16 and are then attached to the base 16 by screws.

Turning now to FIG. 2, the invention may have one or more deflectors 6, 7 below the table top 2. The deflectors 6, 7 redirect heat away from the table top 2 so that the table top 2 remains cool even when the table heater 1 emits a large amount of heat. Below the table top 2 is a heat source, which in FIG. 2 is an emitter assembly 40. In another embodiment of the invention, the heat source may comprise a ring burner. The emitter assembly 40 is located a sufficient distance away from the deflectors 6, 7 so that a great deal of heat radiates out through one or more apertures 55 in grate 56.

Located further below the heating area or combustion chamber is a cabinet assembly 30. In the embodiment shown in FIG. 2, the cabinet assembly comprises a door panel 32 and one or more control panels 34. The door panel 32 can be used to open the cabinet assembly 30 so that a propane tank or other energy source can be stored within the heater table 1. The energy source of the heater is self-contained, thereby making the heater table 1 easily portable. In one embodiment of the invention, the base 16 has wheels 18 which allow for mobility. The wheels 18 could be, for example, swivel-type wheels, ball-type wheels, or fixed-position wheels to allow rolling of the unit over the ground.

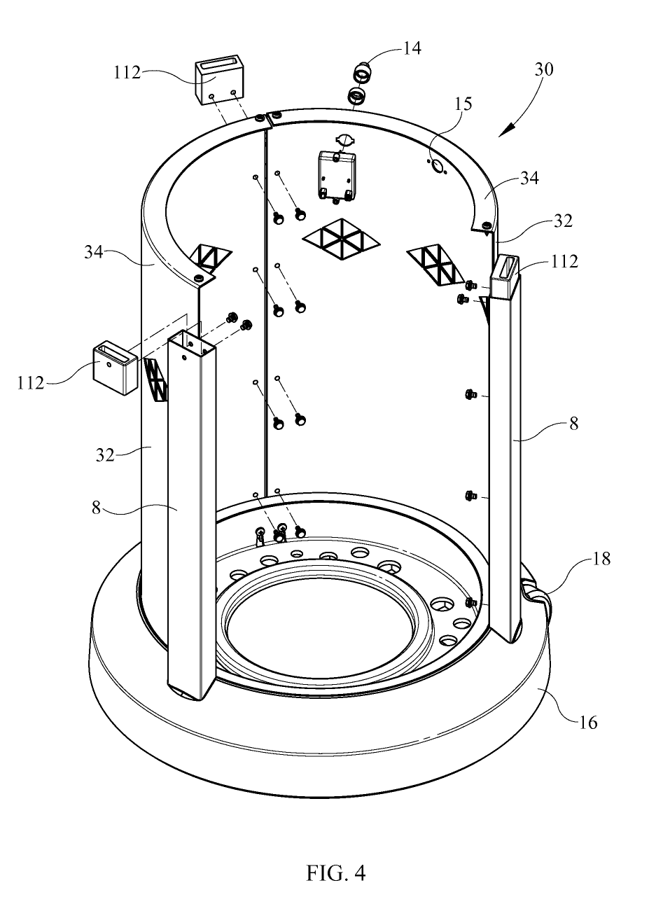

As shown in FIGS. 3 and 4, wheels 18 are rotatably attached to base 16. Base 16 may be hollow and provides space for a propane tank or other energy source. The cabinet assembly 30 generally comprises door panel 32, and control panels 34. Door panel 32 can be opened in order to remove the propane tank after it is empty. Ignitor 14 is also shown in FIG. 4, as is a hole 15 for the control knob 12. Brackets 112 can be attached to support pillars 8 in order to secure control panels 32 in place on top of base 16. As shown in FIG. 4, screws or other fasteners can be used for this purpose.

As is also shown in FIG. 4, base 16 sits at the very bottom of table heater 1 for support. Other types of support structures can also be used with the table heater 1 of the embodiment. The base 16 and cabinet assembly 30 ensure a consistent and stable support for the heat source so that heat consistently emanates from the table heater 1.

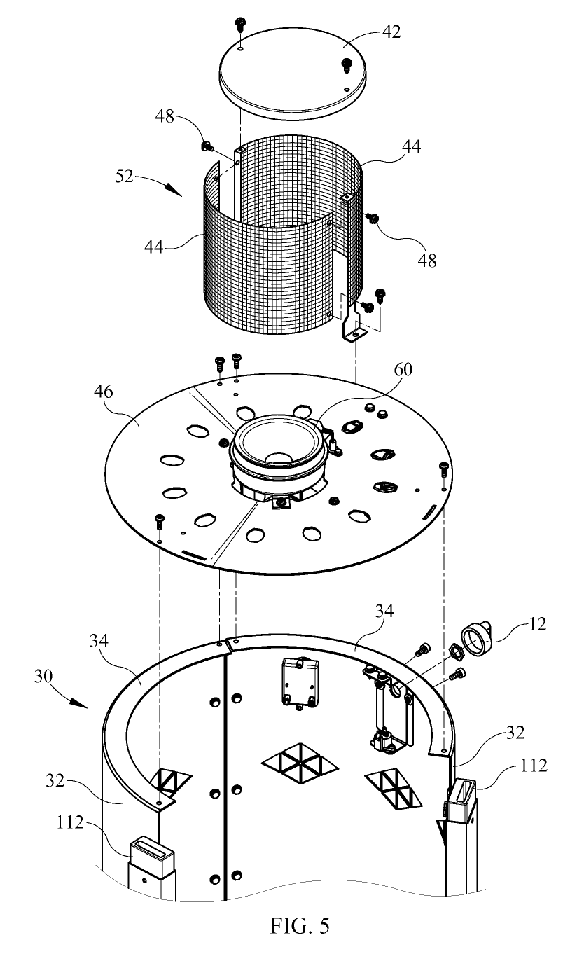

In the embodiment of the invention shown in FIGS. 1 and 5, the heat source of heating area or combustion chamber 50 comprises an emitter assembly 40. The emitter assembly 40 comprises one or more burner screens 44 that can be joined together by screws 48 or other fasteners and covered by an emitter cap 42. The burner screen 44 shown in FIG. 5 is cylindrical, but the burner screen 44 may also be cubical or any other shape that encloses enough space for a burner 60. The burner screen 44 of FIG. 5 preferably comprises wire mesh and has many small openings, which allows heat from the burner 60 to escape.

Below the emitter assembly 40 is a burner support plate 46 to which the burner 60 may be attached. It can be seen that when the burner screen 44 is attached to the burner support plate 46, its radius is approximately half the radius of the burner support plate 46. Having a heat source that is too large could cause excessive heat to be generated from the heating area or combustion chamber 50. As is also visible in FIG. 5, screws or other fasteners attach burner support plate 46 to cabinet assembly 30. Control knob 12 can also be attached to one of the control panels 32.

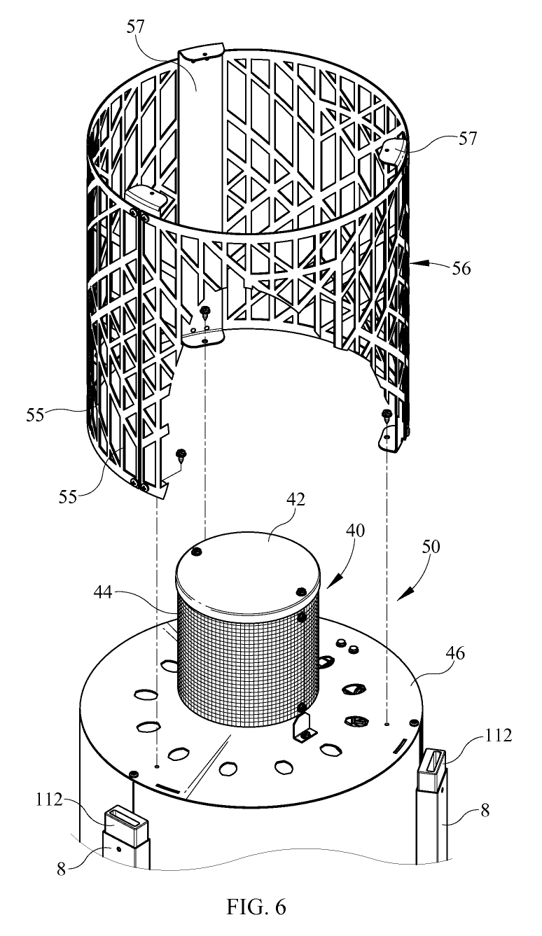

Turning now to FIGS. 1 and 6, once the emitter assembly 40 is attached to the burner support plate 46, grate 56 can be attached to the burner support plate 46 around emitter assembly 40 so that the grate 56 encloses heating area or combustion chamber 50. The grate 56 acts to partially shield combustion chamber 50 from weather interference with the operation of the heat source, and can limit inadvertent user contact with the heating area or combustion chamber 50.

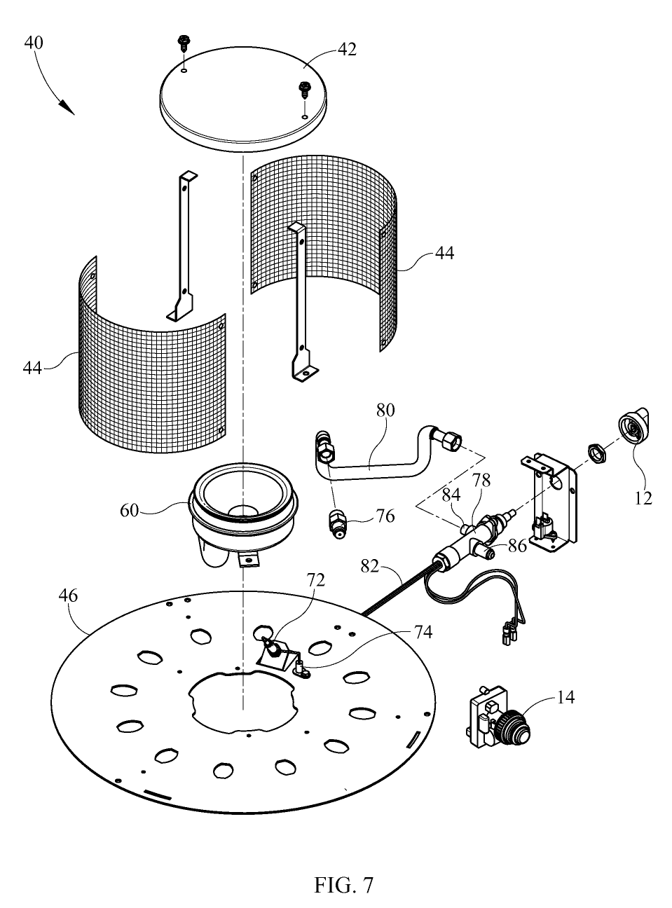

Turning now to FIG. 7, control knob 12 controls the activation of burner 60 within emitter assembly 40. When control knob 12 is pressed and turned, control valve 78 opens, and gas flows through first fitting 84 and burner flex line 80 into injector 76, which in turn injects the gas into burner 60. Gas enters control valve 78 through second fitting 86, which connects to a propane tank or other energy source through a conventional hose and regulator (not shown). When ignitor 14 is depressed, an electronic signal is sent through a wire to ignitor electrode 74 on burner plate 46 so that a spark ignites gas coming through injector 76 to burner 60. When burner 60 ignites, thermocouple 72 sends a signal through thermocouple wire 82 to control valve 78, which activates control valve 78 to stay open. Conversely, if burner 60 goes out, thermocouple 72 senses that condition and sends a signal to control valve 78 activating it to close. When burner 60 is lit, emitter screens 44 absorb heat radiated from burner 60, causing screens 44 to glow red and radiate heat outward through grate 56. As shown in FIGS. 6 and 7, emitter screens 44 are covered by emitter cap 42.

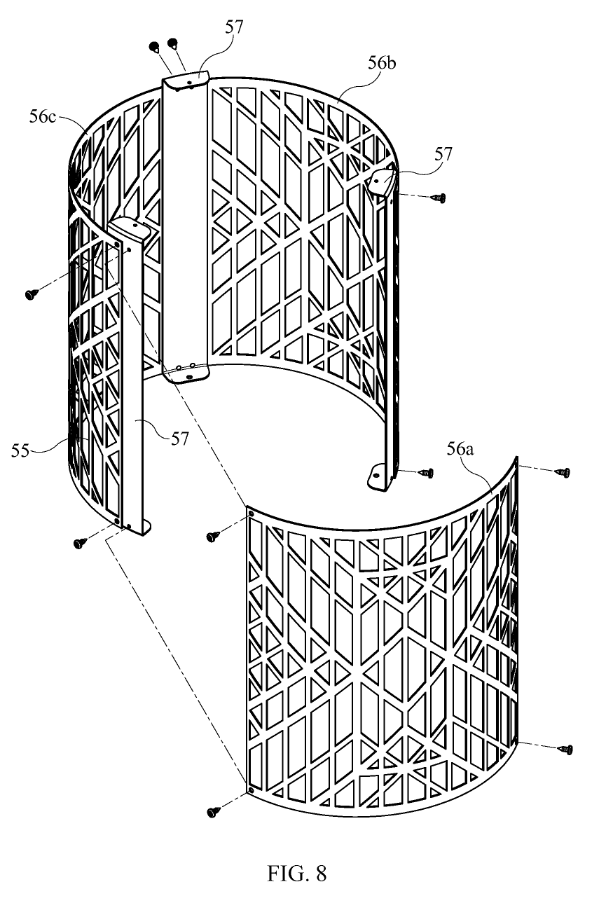

Grate 56 may comprise more than one piece. For example, in the embodiment shown in FIG. 8, for example, grate 56 is formed from three semi-circular segments 56a, 56b, 56c, that are attached to grate pillars 57 and joined together. Grate pillars 57 maintain the shape of grate 56, which circumscribes heating area or combustion chamber 50.

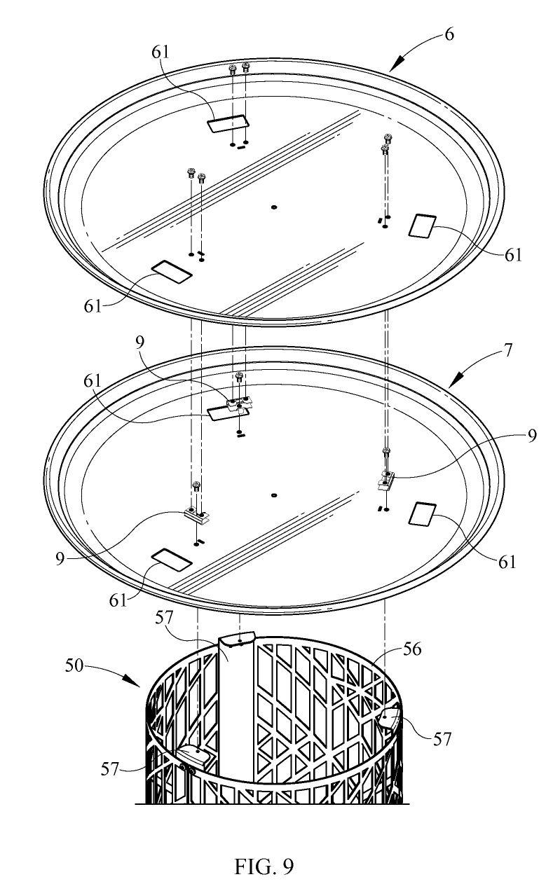

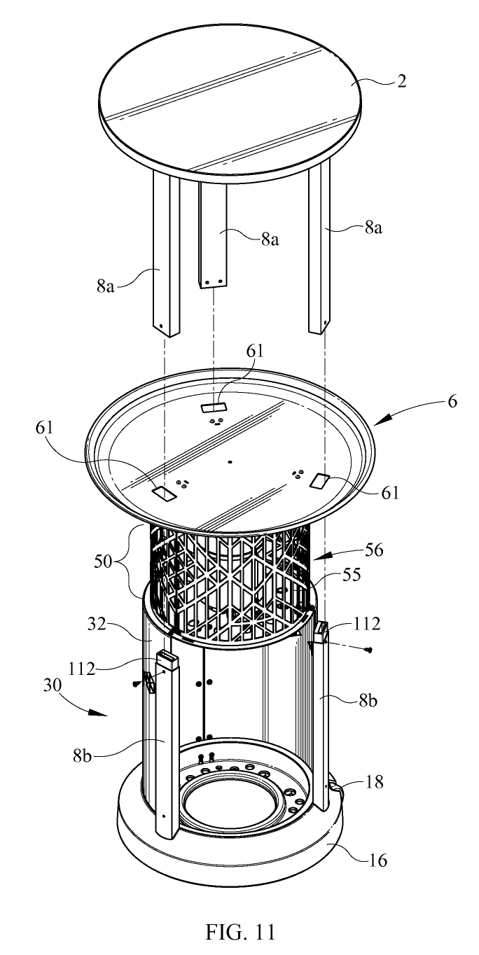

FIG. 9 shows one embodiment of the deflectors 6, 7 in more detail, illustrating them in the shape of a pan. In this embodiment, a top deflector pan 6 is located above a bottom deflector pan 7, and deflector brackets 9 separate the two pans 6, 7 from each other. Deflector brackets 9 also have holes in them through which the pans 6, 7 can be attached to each other by screws, for example, and in turn can be attached, also for example by screws, to grate pillars 57. Deflector pans 6, 7 also have deflector openings 61 through which the upper portions of support pillars 8a can be inserted, as shown in FIG. 11, for attachment to corresponding lower portions of support pillars 8b. However, many alternative structures may be utilized. The pans are primarily intended to provide sufficient surface area over which heat may dissipate to guard against overheating of table top 2. Preferably, the table top 2 is made of a heat insulating material to further guard against overheating. Any number of deflector pans may be utilized in a variety of constructs as needed in order to maintain the temperature of the table top so that it is sufficiently cool for use.

The space between the pans 6, 7 created by deflector brackets 9 allows heat between the pans to dissipate so that the top deflector pan 6 is somewhat cooler than the bottom deflector pan 7. As shown in FIG. 11, the deflector pans 6, 7 are much wider than the circumference of grate 56 and the enclosed heating area or combustion chamber 50 in order to deflect heat away from the large table top 2 above them and towards the lower extremities of people standing or sitting around the table heater.

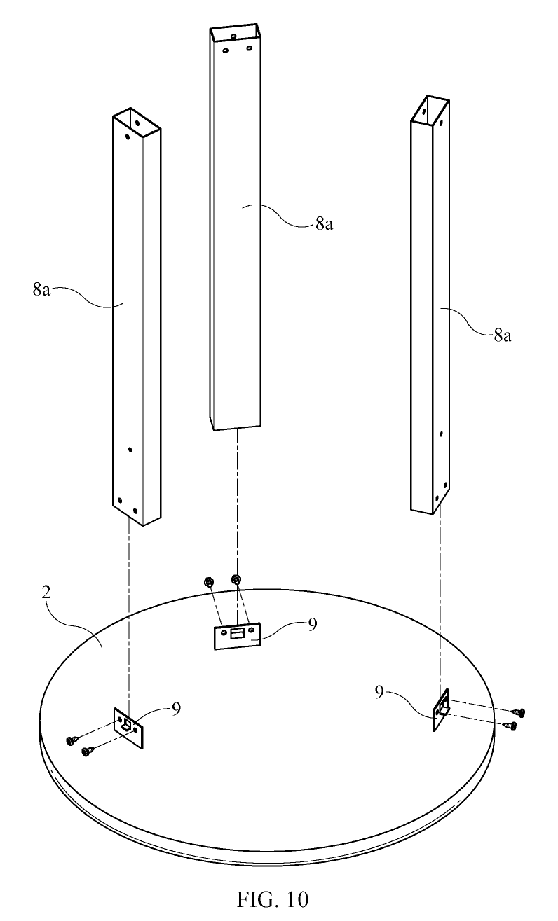

FIG. 10 shows an inverted view of the table top 2 before the table top is attached to the rest of the table heater 1. The upper portions of support pillars 8 are attached to the table top by means of brackets 9 through use of screws or other fasteners and extend vertically down the outside of the heating area or combustion chamber 50 and grate 56 as shown in FIG. 11. After the upper portions of support pillars 8a are attached to the table top 2, they can slide through deflector openings 61 and attach to the corresponding lower portions of support pillars 8b as shown in FIG. 1. The upper portions of support pillars 8a may also be attached to the grate 56 by appropriate means (not shown) for added support if desired.

As previously referred to with reference to FIGS. 1 and 7, the cabinet assembly 30 has an ignitor 14 and a control knob 12. The ignitor 14 and control knob 12 should be placed where they can respectively communicate with the ignitor electrode 74 and the energy source. It is normally most convenient to place them on the outside of one of the panels 32 of cabinet assembly 30, as shown in FIG. 1, to make them readily accessible to a user.

To light the burner 60, the control knob 12 is preferably designed to be pressed inward and turned to the start position. While the knob 12 is still pressed in, the ignitor 14 is then repeatedly pressed until the burner 60 is lit. After the burner 60 is lit, the control knob 12 is released. To adjust the heat level, the knob 12 can be rotated to adjust the control valve to the desired setting.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

We claim:

1. A combination table and heater comprising:
a table top;
a heating area below said table top, wherein said heating area has means for allowing heat to escape laterally from said heating area; and
a heat source within said heating area and below said table top.

2. The combination table and heater of claim 1, wherein said heat source is positioned such that heat from said heat source is capable of exiting said heating area in more than 180 degrees around said heater and below said table top.

3. The combination table and heater of claim 2, wherein said heat source is positioned such that heat from said heat source is capable of exiting said heating area in substantially 360 degrees surrounding said heater and below said table top.

4. The combination table and heater of claim 1 further comprising at least one deflector positioned between said table top and said heat source, wherein said at least one deflector is capable of dissipating or reflecting heat from said heat source.

5. The combination table and heater of claim 1 further comprising a base that is capable of supporting said combination table and heater.

6. The combination table and heater of claim 5 further comprising
a storage space situated between said heating area and said base; and
a housing that encloses said storage space.

7. The combination table and heater of claim 6, wherein said storage space is capable of storing a propane tank.

8. The combination table and heater of claim 5 including wheels rotatably mounted to said base whereby said table and heater are made portable.

9. The combination table and heater of claim 1, wherein said heat source is a gas-powered radiant emitter.

10. The combination table and heater of claim 9 including a manually operated ignitor and a manually operated gas control valve, each communicating with said heat source.

11. The combination table and heater of claim 1, wherein said heat source is a ring burner.

12. The combination table and heater of claim 1, wherein said table has a top, bottom, and edge, said table and heater further comprising at least one heat guard rail attached to said edge of said table.

13. The combination table and heater of claim 1, wherein at least a portion of said table is constructed of an insulating material.

14. The combination table and heater of claim 1, wherein said heater has a 360 degree heating area such that all areas below the edge of said table are capable of being heated.

15. The combination table and heater of claim 1, wherein said means comprises at least one opening that allows heat to escape laterally from said heating area.

16. The combination table and heater of claim 1, wherein said means comprises a grate that allows heat to escape laterally from said heating area.

17. A combination table and pillar heater comprising:
a cabinet;
a base adjacent to and supporting said cabinet;
a self-contained energy source positioned within said cabinet;
a heating area situated above said cabinet and having at least one lateral opening;
a heat source within said heating area; and
a table top above said heating area.

18. The combination table and heater of claim 17 further comprising at least one deflector pan positioned between said heat source and said table top.

19. The combination table and heater of claim 17 further comprising a heat guard rail attached to said combination table and heater and extending away from said table.

20. The combination table and heater of claim 17 further comprising at least one pillar support traversing the height of said cabinet.

21. The combination table and heater of claim 20, wherein said at least one pillar support is attached to the top of said base at its radial edge.

22. The combination table and heater of claim 17, wherein said base comprises wheels, whereby said table and heater are made portable.

23. A table and heater combination comprising:
an insulating table top mounted on a frame above at least one deflector, said at least one deflector forming the top of a heating chamber having at least one burner,
said heating chamber having a plurality of apertures allowing heat emanating from said burner to exit said chamber,
wherein said table top is separated from said burner by said deflector to remain cool for use, and said deflector and plurality of apertures redirect most of the heat generated from said burner to escape said chamber.

24. The insulating table top of claim 23, further comprising a cabinet adjacent to and below said heating chamber.

25. The insulating table top of claim 24, wherein an energy source for said burner is self-contained within said cabinet said energy source being in flow communication with said burner.

26. The insulating table top of claim 25, further comprising a base below said cabinet.

27. The insulating table top of claim 26, wherein said base further comprises wheels whereby said table and heater combination is made portable.

28. A portable combination heater and table comprising:
a base having wheels;
a storage cabinet positioned above said base and capable of retaining an energy supply;
a burner compartment having a burner capable of being put in flow communication with said energy supply, said burner compartment being surrounded by a grate;
a deflector pan above said burner compartment and retained below said table, said table being retained in position above said burner compartment by at least one support;
wherein said deflector pan and said grate work in combination to allow heat to escape said burner compartment in substantially 360 degrees.
